(19) United States
(12) Patent Application Publication
(10) Pub. No.: US 2011/0175444 A1
(43) Pub. Date: Jul. 21, 2011

(54) Portable Power System

(76) Inventors: Yuki Yunes, Vernal, UT (US); Yuji Yunes, Vernal, UT (US); Brett Haslem, Vernal, UT (US); Michael Cochran, Vernal, UT (US)

(21) Appl. No.: 12/690,110

(22) Filed: Jan. 19, 2010

(51) Int. Cl. H02J 4/00

(52) U.S. Cl. 307/23; 307/25

(57) ABSTRACT

A remote station may be constructed such that components or the station arc placed upon a skid and transported to a remote site. When deposited at the remote site, the remote station may cause a minimal disturbance on the ground while providing the necessary remote services, such as power and communications, because the skid may simply rest upon the ground, and the components rest atop the skid.

### THE FIELD OF THE INVENTION

The present invention relates to remote power generation, control and communication systems. More specifically, the present invention relates to minimally invasive remote power generation system.

### BACKGROUND

Many oil and gas wells are located in various remote places without access to the electric power grid. Monitoring of these remote wells to determine the production and status of the remote wells is critical to efficient production of those wells. Communications cannot also be difficult in such remote environments.

Additionally, some oil and gas wells are located in environmentally sensitive areas. These oil and gas wells may be subject to environmental impact regulations arising from local, state, and federal laws. The land may also be subject to other agreements relating to the environmental impact of the wells and associated technology.

In order to provide communications for workers in the field and to monitor pump status, remote communications and power stations are often built on site. Remote station construction is often started by hauling the individual components to the remote area. A concrete or other base may be constructed on-site with concrete forms brought in or constructed on site. Because the well sites are typically remote, considerable man hours can be wasted moving construction personnel back and forth to the site. Additionally, the various components needed for the power station must be taken to the site, increasing costs and adding time to the project.

In addition, a particular site may further complicate construction of a power station adjacent the wells. For example, the composition of the soil and surrounding land may be different from station. site to station site. Environmental concerns may reduce the desirability of disturbing the land.

Furthermore, weather conditions and monetary issues can complicate the construction of power supplies in these remote locations. If workers must travel for several hours to get to the site, there is always the possibility that weather conditions will change while the workers are in route. Thus, hours of travel may be wasted if conditions change and are no longer conducive to construction.

### SUMMARY OF THE INVENTION

It is an object of the present invention to provide a minimally invasive remote power generation and communication system in the form of a remote station.

According to one aspect of the invention, the remote station is constructed upon a base which can be delivered with minimal environmental impact. The remote station may be constructed in a weather controlled environment where workers are readily available. Once completed, the remote station can be loaded onto a rig up truck or some ether delivery vehicle and driven to the remote location where power and/or communication is needed. At the remote location, the remote station may be lowered onto the ground by the truck and finalized for operation.

The base construction and deployment process provide advantages including a consistent build, reduced on-site cost, and low environmental impact. Additionally, the remote station can be used again in other places should it no longer be required at the initial location. This not only substantially reduces cost, it also reduces impact to local environments created by disassembling a power station.

According to one aspect of the invention, the remote station may include a skid such that it may be placed and removed with minimal environmental impact. A rig up truck or a pivoting flatbed truck can deliver the skid and accompanying station to the desired location. When the station is no longer needed, the truck may attach a winch to the remote station and load the base on the flatbed portion of the truck. Once loaded, the truck may return the remote station for service or to the next job site. The placement and removal causes relatively minor environmental impact because only the truck and skids cause minimal surface disruption. This minor environmental impact is in contrast to the filling of holes and piecemeal removal of on-site constructed materials, which often includes the abandonment of all underground materials, such as concrete. It also substantially reduces lost time associated with moving crews to the site to construct the power station.

These and other aspects of the present invention are realized in a minimally invasive remote power generation. They can also be used for pump control and communication systems as shown and described in the following figures and related description.

### BRIEF DESCRIPTION OF THE DRAWINGS

Various embodiments of the present invention are shown and described in reference to the numbered drawings wherein:

FIG. 1 shows a side view of a remote station with backup power:

FIG. 2 shows a front view of a remote station with backup power;

FIG. 3 shows a top view of a remote station with backup power;

FIG. 4A shows a side view of a flat bed tow truck unloading/loading a remote station;

FIG. 4B shows a side view of a rig up truck loading a remote station:

FIG. 5 shows a side view of a remote station with alternative power sources;

FIG. 6 shows a front view of a remote station with alternative power sources;

FIG. 7 shows a top view of a remote station with alternative power sources;

FIG. 8 shows a top view of a skid portion ofa remote station;

FIG. 9 shows a side view of a skid portion of a remote station;

FIG. 10 shows a front view of a skid portion of a remote station;

FIG. 11 shows a top view of a skid portion of a remote station with a tower; and

FIG. 12 shows a diagram of a power supply for a remote station with alternative power sources.

It will be appreciated that the drawings are illustrative and not limiting of the scope of the invention which is defined by the appended claims. The embodiments shown accomplish various aspects and objects of the invention. It is appreciated that it is not possible to clearly show each element and aspect of the invention in a single figure, and as such, multiple figures are presented to separately illustrate the various details of the invention in greater clarity. Similarly, not every embodiment need accomplish all advantages of the present invention.

### DETAILED DESCRIPTION

The invention and accompanying drawings will now be discussed in reference to the numerals provided therein so as to enable one skilled in the art to practice the present invention. The drawings and descriptions are exemplary of various aspects of the invention and are not intended to narrow the scope of the appended claims.

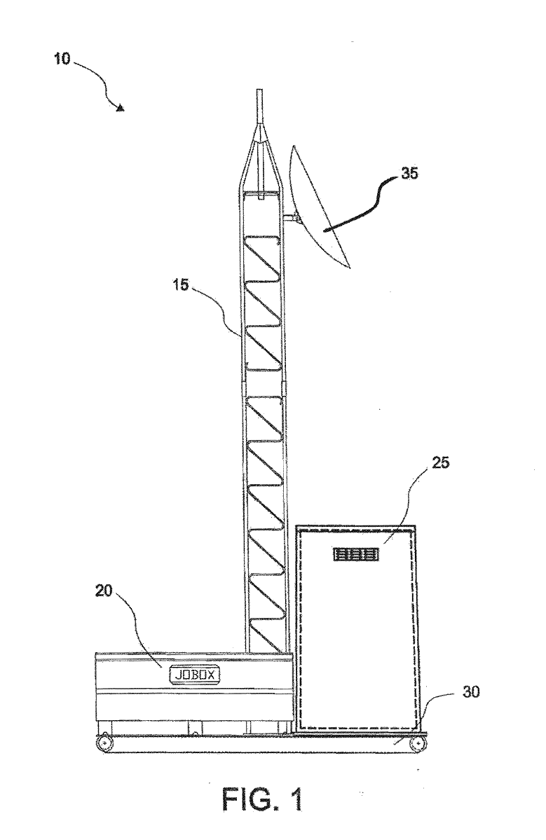

Turning now to FIG. 1, a side view of remote station 10 with backup power is shown. Tower 15, one or more of storage boxes 20 and secondary box 25, such as a fiberglass building, may be attached to a base such as skid 30. By pre-fabricating these components and attaching them to a base, the remote station may he carried as a complete unit to a remote site.

In one embodiment, the remote station may be fully constructed away from the remote site and then transported to the remote site. The construction of the skid may then take advantage of the economies of scale of building multiple skids and enable construction in a controlled environment, such as in a warehouse. Additionally, creation of a preassembled remote station can reduce the transportation cost of moving raw and partially completed materials to the remote site, as well as site excavation costs. Furthermore, a number of construction workers are not required to be transported to remote locations to build the power /communications system.

The remote station may also be constructed such that portions of a remote communication system may be quickly attached on-site. In one embodiment, the tower 15 may be carried separately from the skid 30 (or pivotably mounted to the skid), thereby allowing a truck to carry the station beneath highway overpasses, power lines, etc. The tower 15 may then be quickly positioned or assembled at the remote site and secured to the skid 30 with fasteners such as bolts, nuts and sleeves.

The tower 15 may include accessories depending on the need. In the embodiment shown in FIG. 1, antenna 35 may be added to the tower to allow communications as needed. One problem with stations is that it is often difficult to have consistent communications. Workers may have difficulty communicating with a control base and it may be difficult to monitor the status of the pumps. By including the tower 15, the remote station 10 can provide improved communications to other remote locations or to a central base. Other accessories may include sensors, various types of power generation and storage devices and lighting.

The storage box 20 may include individual components and electronics related to the operation of the skid or its purpose. For example, the storage box may hold all or part of a power subsystem. In one embodiment, the storage box contains a subsystem for storing power, such as backup batteries as a regular or emergency power source. The storage box 20 may be environmentally sealed and/or locked, such that sensitive components may not be exposed to the weather, moisture, other potentially damaging contaminants or tampering by unauthorized people.

In a current embodiment, a plurality of large batteries are disposed in the storage box 20. The batteries hold an amount of needed electricity. For example, current embodiments can hold up to 57,600 watt/hours of electricity and additional capacity can be added. Such a supply of electricity enables powering of the remote station 10 for its desired use. For example, remote station 10 as shown in FIG. 1 also serves as a communications system. The substantial amount of power which is held by the batteries allows for a prolonged use of the communications system even in harsh conditions.

The secondary box 25 may contain components that may require more access than the storage box 20. The secondary box 25 may contain interconnects and portions of the systems that may require maintenance. In one embodiment, the secondary box 25 contains the transmitter interface and power connectors for the tower 15 communications systems, including those routed to the antenna 35. The separation of parts that require more frequent maintenance from those that do not provide the advantage of reducing the exposure of the elements to portions of system that do not require frequent maintenance. The separation may further have the advantage of keeping potentially harmful components away from more sensitive components. This may include separation of batteries from electronics.

An advantage of this system is that these components described may be placed without any significant ground disturbance, such as concrete, thus not significantly altering the environment.

A method of using the device may include several steps, such as: providing a base; attaching one or more subsystems to the base, at least one of the subsystems comprising means for generating power; loading the base onto a vehicle; transporting the base to a site remote from where the base was loaded onto a vehicle; and unloading the base at the remote site.

The method may optionally include: attaching a communications subsystem to the base; monitoring the remote station for subsystem failures; configuring the communications system to send a message in the event of a subsystem failure; and/or attaching a loading line to a loading connector on the remote station prior to unloading the remote power station.

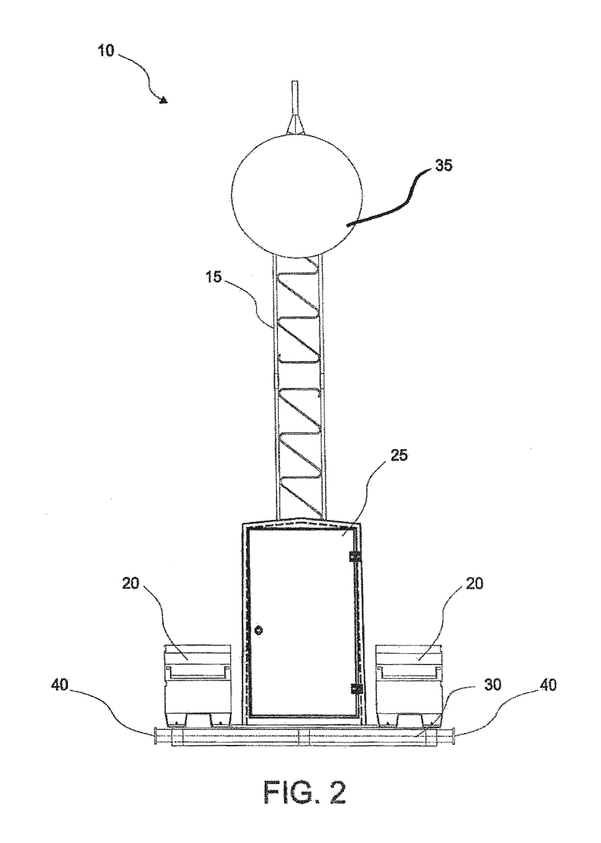

Turning now to FIG. 2, a front view of a remote station 10 with backup power is shown. The remote station 10 may include one or more storage boxes 20, secondary boxes 25 or other components. In one embodiment, two storage boxes 20, are used to contain 24 batteries weighing 120 pounds each. The batteries are advantageous for several reasons. First, the batteries store substantial amounts of power as noted above. Additionally, the batteries weight help hold the skid 30 in place. Thus, in the event of high winds or other harsh weather, the weight of the batteries will help hold the skid upright. To this end, the storage boxes 20 may be placed on the skid 30 in such a configuration that they will assist in resisting tipping of the skid if the tower 15 is subject to high wind conditions.

The remote station 10 may also include loading connectors 40 extending from the skid 30. The loading, connectors 40 allow a winch or other loading mechanism to be attached to the skid 30 to facilitate placement and removal of the skid and the structures attached thereto.

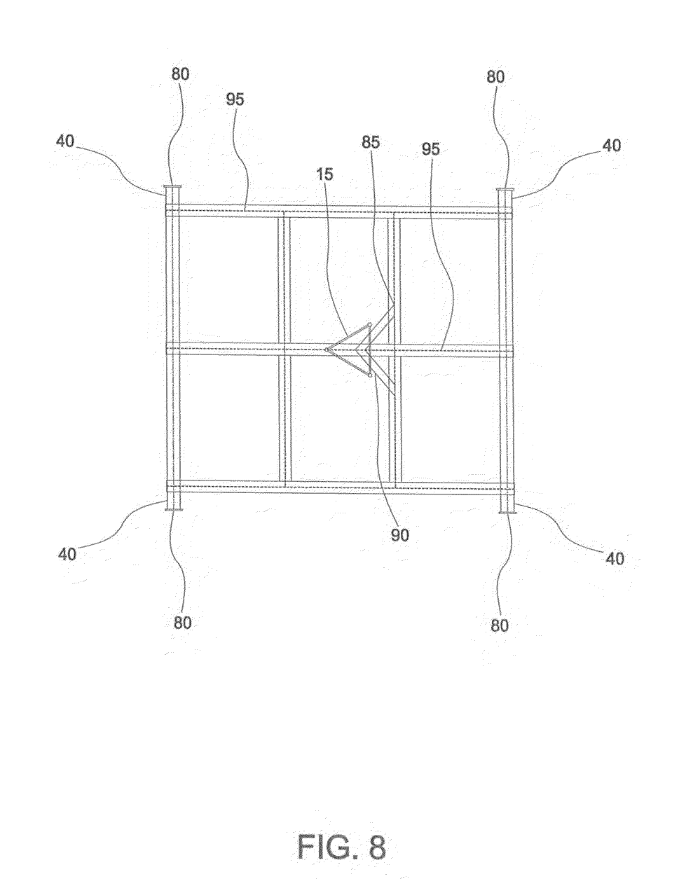

The loading connectors 40, may comprise a portion of the beam of the skid extending beyond the side of the skid and a loading flange 80 (shown in FIG. 8) to prevent a loading line from sliding off of the connector. This structure may be better seen in FIG. 8. The loading connector may allow the remote station 10 to be easily secured to a vehicle such as a truck with winch and flatbed. The remote station 10 may thus be easily loaded and unloaded by using the winch to pull the remote station 10 onto a vehicle, such as a flat bed tow truck or a rig up truck.

Another advantage of the remote station 10 disposed on the skid 30 is that it allows communications equipment to be oriented as desired. Many communications systems today use point-to-point wireless. In such systems, the antenna must be pointed generally toward the relay antenna. Should the antenna on the remote station need to be reoriented, the skid 30 need merely be rotated to get the desired positioning, Likewise, the skid could be oriented for maximum exposure of panels for generating solar energy. It will be appreciated, of course, that the orientation of the tower and or solar panels on the skid could also be used instead of rotating the skid itself.

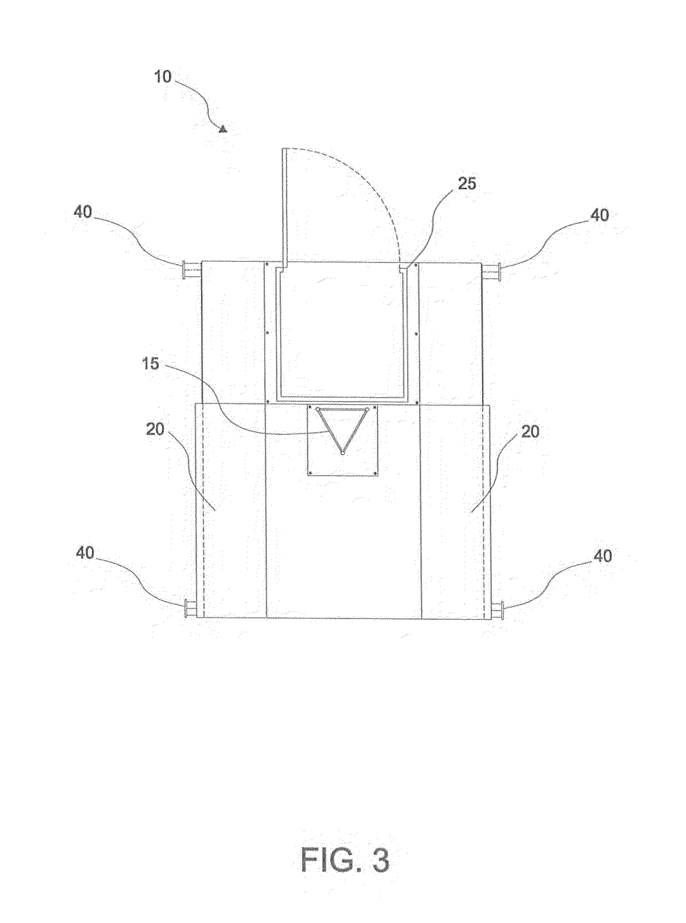

Turning now to FIG. 3, a top view of a remote station with backup power is shown. As may be seen the remote station 10 may be constructed to lit atop a skid 30. Placement of components may be optimized to give the skid 30 a low center of gravity near the middle of the skid. In the embodiment shown in FIG. 3, the antenna may be placed in the middle of the skid. Storage boxes 20 may be placed as a counterweight to the secondary box. A lower, centered, center of gravity may allow the remote station to remain upright longer in harsh environments.

In one embodiment remote station may have four loading connectors 40, such that the remote station may be captured and moved by the front or back. This may reduce the complexity of removing the remote station.

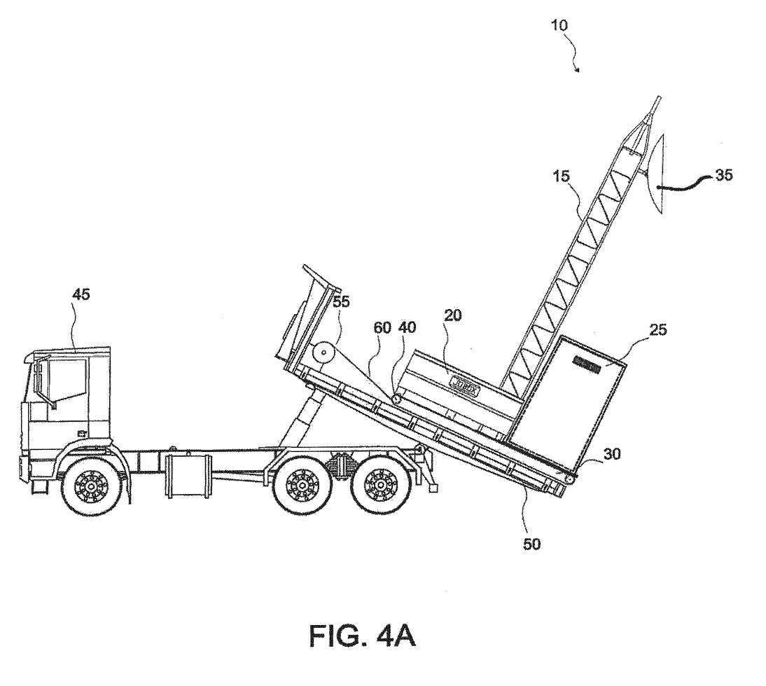

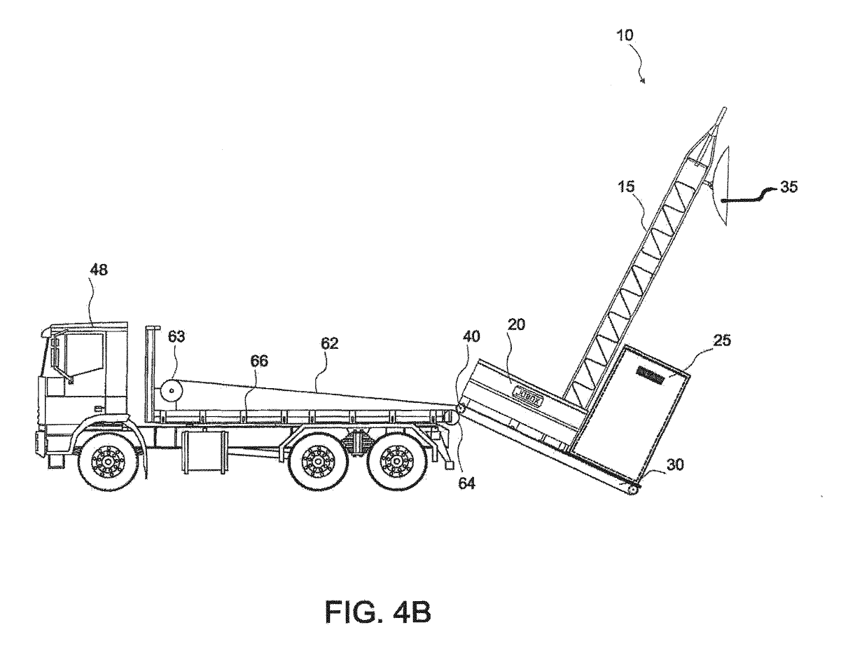

Turning now to FIG. 4A, a side view of a flat bed tow truck 45 unloading a remote station 10 is shown. The tow truck 45 may drive to the remote site with only one or two workers, rather than a construction crew. At the remote site, driver of the truck 45 may cause the flatbed portion 50 of the truck 45 to lower. A loading line 60 may be attached to the loading connectors 40 of the remote station 10. The remote station 10 may then be slid on its skids 30 off the flatbed portion 50 until the remote station 10 is resting on the ground. The loading line 60 can be use to further position the remote station if desired.

Removal of the remote station 10 can be just as easy. The loading line 60 is attached to the loading connectors 40 and the skid 30 is pulled on to the flatbed portion 50 of the truck. Once loaded, the flatbed portion 50 is returned to its normal position and the remote station is secured to prevent movement during transport. After tethering the remote station 10 to the truck 45, the truck 45 may transport the remote station 10 to the next remote site or return it for maintenance. All of this can be accomplished in much less time than building a conventional power/communications system. Further, there may be much less disturbance to the environment.

Delivering the remote station 10 is similar to the loading steps above, but in reverse. In some cases, the truck 45 may have to pull forward once the skid of the remote station 10 has contacted the ground, such that the remote station 10 may continue its descent down the flatbed portion 50.

Turning now to FIG. 4B, there is shown a rig up truck 48 loading the remote station 10. Unlike a flatbed tow truck, the bed of a rig up truck 48 does not lower. Rather, the skid 30 is attached to a winch line 62 extending from a winch 63 adjacent the cab of the truck. As the winch line 62 is drawn in, it lifts one end of the skid 30 over a large roller 64 at the rear end of the rig up truck 48 and pulls the skid onto the bed 66 of the truck. Thus, in a manner of minutes the entire remote station 10 can be loaded or unloaded at a desired location.

Similarly, the method for providing a remote power station may include the steps, such as: providing a skid; attaching a power subsystem to the skid; attaching one or more storage containers to the skid; loading the skid onto a vehicle; transporting the skid to a site remote from where the skid was loaded onto a vehicle; attaching a loading line to a loading connector on the remote station; using the loading line to slowly lower the skid down a ramp; and unloading the skid at the remote site.

The method may optionally include the steps of: selecting a skid having at least one solar panel attached to the skid and generating power from the at least one solar panel; selecting a skid having batteries attached thereto and storing and receiving power from one or more batteries; configuring a load controller to send excess power received from the at least one solar panel to charge the batteries; weatherproofing the one or more storage containers; placing portions of subsystems that require more frequent maintenance in a more accessible storage box; and/or using a fiberglass building as the more accessible storage box.

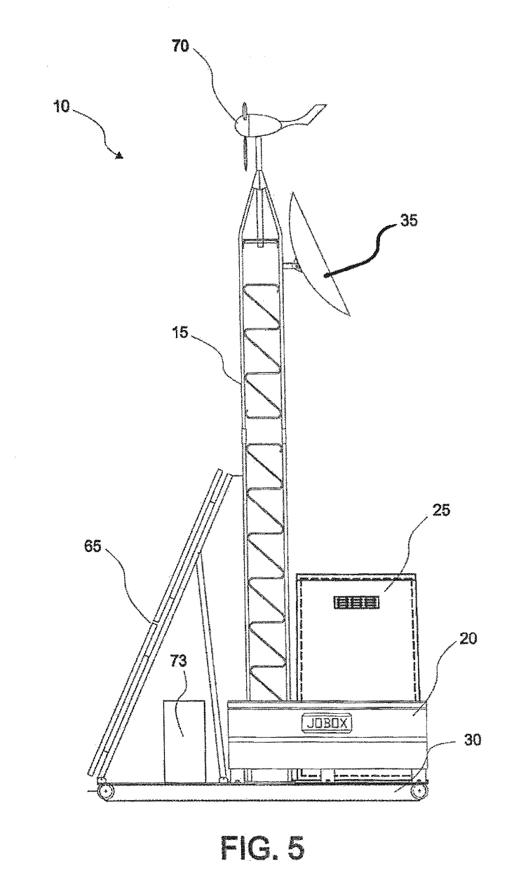

Turning now to FIG. 5, a side view of a remote station 10 with alternative power sources is shown. The remote station 10 may include alternate forms of power generation including one or more solar panels 65 and/or wind turbines 70. The remote station 10 thus equipped may be used to power a pump if necessary, or may simply be used to monitor the status of the pump or other machine and provide communications with a remote control center. The solar panel(s) 65 and/or wind turbine(s) 70 enable long term management and reporting of any problems from remote areas in which it may otherwise take days to realize that there is a problem.

In one embodiment, the intermittency and non-dispatchable nature of solar and wind energy is resolved by adding banks of rechargeable batteries. During periods of power generation where power demand is less than power generated, the excess power may be stored in the rechargeable batteries. Thus, the remote station may be configured such that electrical power generated may be stored to smooth the power generation curve to fit demand. As noted above, in one embodiment the batteries can readily hold 57,600 watt hours of electricity (larger storage capacity can be added if desired). One or more solar panels 65 can generate 780 watts of electricity and the wind turbine can generate 200-3000 watts depending on its size. Thus, on a windy or sunny day, the remote station can generate a substantial amount of power. Any power generated which is not needed goes to recharge the batteries, which can power the remote station and associated communications equipment, etc., for a prolonged length of time.

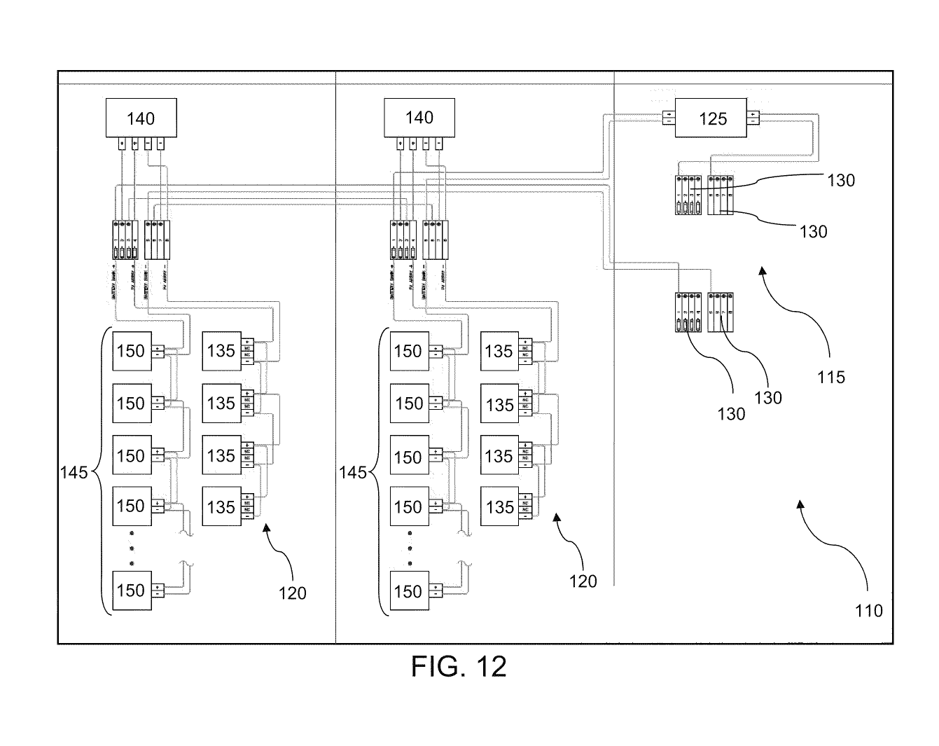

Power output may be selectable and tailored to the remote site needs. While individual power generation may operate at voltages or settings incompatible with the remote site equipment, the remote station 10 may convert the power into usable energy. In one embodiment, the remote site equipment is voltage sensitive. Thus the remote station 10 may be configured to provide the appropriate voltage, including 6 volt, 12 volt, 24 volt and 48 volt DC feeds or AC feeds of 120 volt or 240 volt feeds. In fact, the remote station may be configured to provide multiple different power connections tailored to the remote site equipment. An example of a power connection may be seen in FIG. 12.

While discussed above as a single remote station 10, it will be appreciated that a number of remote stations can be connected together in series or in parallel to provide greater amounts of power. Thus, for example, if a remote site is an oil or gas well, a plurality of solar panels may gather enough electricity to power the pump during the clay, but may require other power needs at night. The rechargeable batteries in the storage box 20 may provide the power needed during the night time. In the event of a major power failure, such as solar panel 65 destruction, a small wind turbine 70 may provide enough power for communications equipment to send a message regardingt the failure. Additionally, a small fuel powered generator 73 with automatic generator start could also be included to provide emergency power in the event of battery failure or environmental conditions not conducive to wind or solar power generation.

It will also be appreciated that each remote station need not be the same. For example, there may be no need to have multiple communications systems on a number of remote stations which are connected together in series or in parallel. The lack of the tower 15 and dish 35 may leave additional space for additional solar panels, or generators which can run on other types of fuel. Thus, for example, a pair of remote stations 10 could be used in a very remote region which is difficult to get to. If the solar or wind generation systems were to fail, a generator disposed on one skid could be used to replenish the batteries until someone can arrive to repair the renewable energy systems.

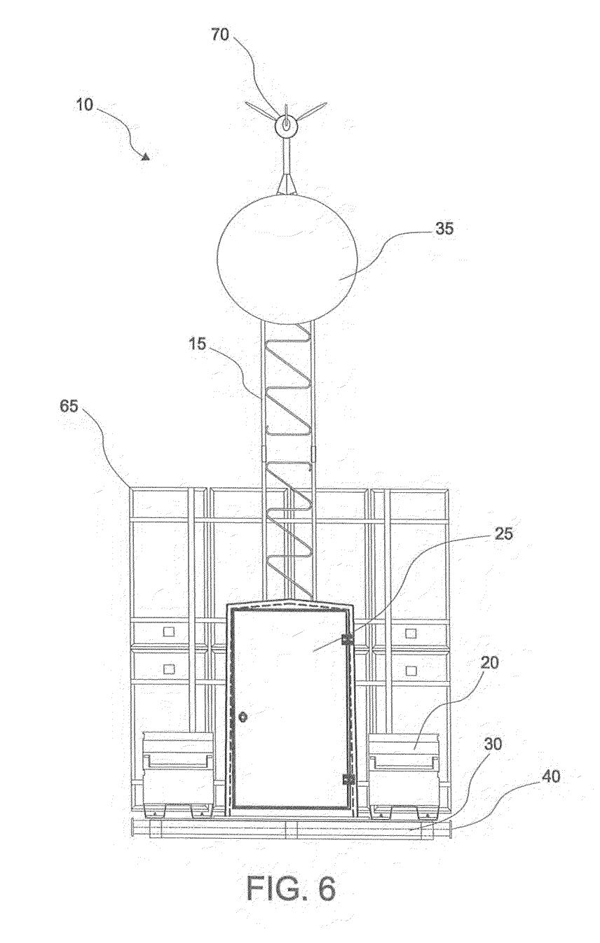

Turning now to FIG. 6, a front view of a remote station with alternative power sources is shown. In the embodiment shown in FIG. 6, the remote station 10 may be constructed to have a minimal wind profile while maintaining an adequate center of balance. In the embodiment shown in FIG. 6, the storage boxes 20 and secondary box 25 are placed behind the solar panel. This may result in the bulk of the wind force placed against the front of the solar panel 65 or divided against the storage boxes 20, secondary box 25 and solar panel, depending on the wind direction.

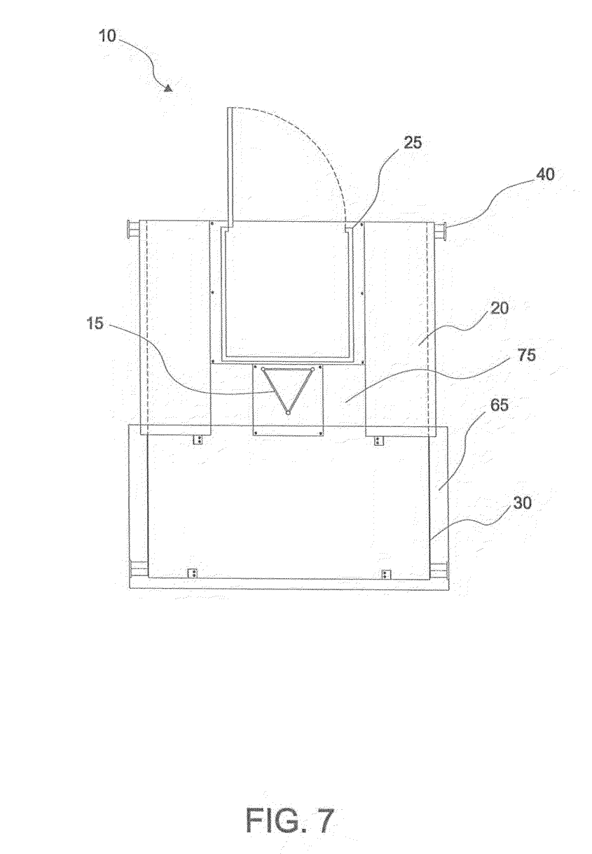

Turning now to FIG. 7, a top view of a remote station with alternative power sources is shown. Depending on the need, the base 75 or skid 30 of the remote station may be filled to lower the center of balance and correspondingly increase the remote station's 10 resistance to wind and elements. In one embodiment, the area between the base and skid is filled with concrete, metal or some other heavy filler.

Turning now to FIG. 8, a top view of a skid 30 of a remote station is shown. The skid may include loading connectors 40, cross braces 85, rails 90 and reinforcing braces 95. As noted above, the loading connectors may be connected to a loading line. Loading flanges 80 may be added to the loading connectors 40, to prevent slipping of loading connector off of the loading connectors 40.

Cross braces 85 may be added for rigidity and support of the remote station. Special structures placed on the skid may require further reinforcement braces. In one embodiment, a tower is added to the skid with corresponding reinforcing braces 90 attached to cross braces 85.

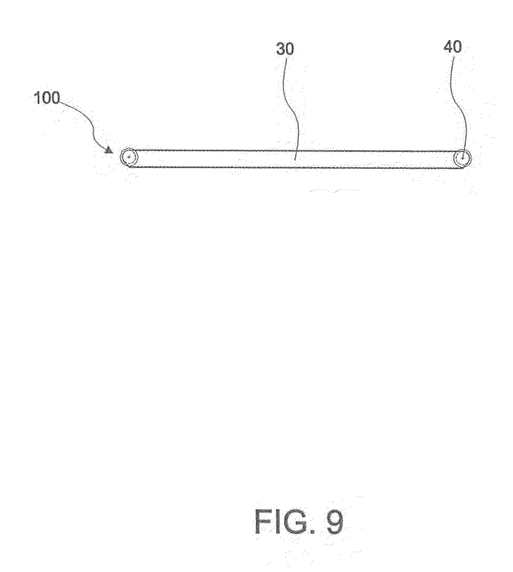

Turning now to FIG. 9, a side view of a skid portion of a remote station is shown. The skid end 100 may be angled upward and rounded to aid in the delivery or removal of the skid. The angle and rounding of the skid end 100 may present a surface that allows the skid 30 to slide or rotate into position on the desired surface.

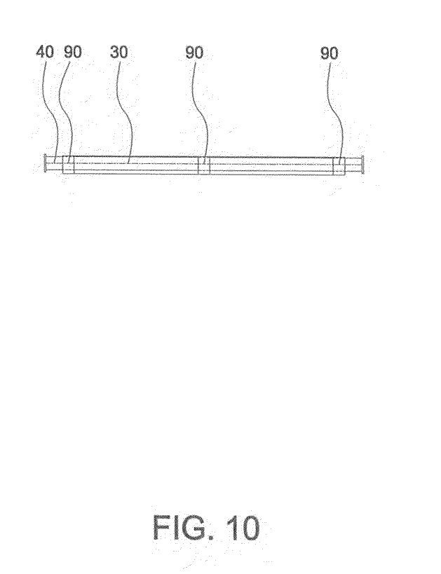

Turning now to FIG. 10, a front view of a skid portion of a remote station is shown. The skid 30 may further comprise rails that extend below the bottom plane of the skid. Thus, the rails may provide a reduced surface to a ground plane. The rails may also have reduced friction with the ground if the skid is slid along the rails' axis. This reduced surface and friction may aid in the lateral movement of the skid, such as during delivery or removal of the skid. Furthermore, the reduced surface may also aid in reducing the environmental impact on the remote site when compared with other methods, such as excavation and/or cement poured on site.

A method of providing an environmentally sensitive remote power and communications station may include the steps, such as: providing a skid; attaching one or more subsystems and one or more communications devices to the skid; loading the skid onto a vehicle: transporting the skid to a site remote from where the base was loaded onto a vehicle; unloading the skid at the remote site; and preparing the skid to hold substantial portions of the attached subsystems at the remote site.

The method may also optionally include the step of adding a filler to the skid to reduce the center of gravity associated with the skid and attached subsystems.

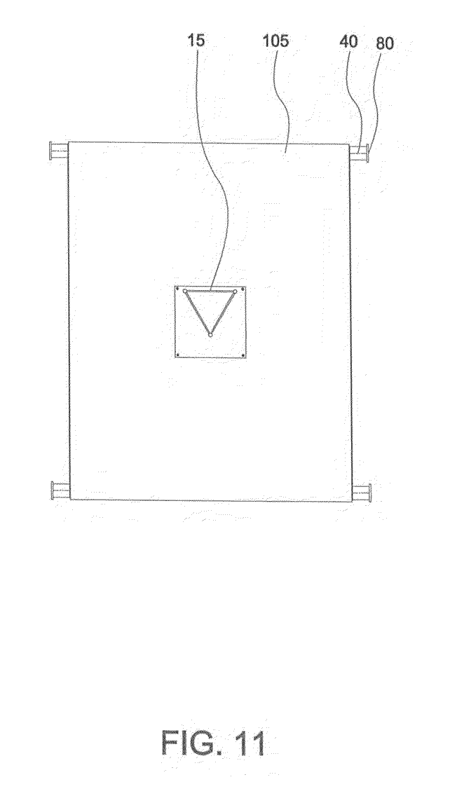

Turning now to FIG. 11, a top view of a skid portion of a remote station with a tower is shown. The surface 105 of the skid may or may not be present. A surface 105 that is solid may aid in the attachment of various devices and reduce the weathering of the skid and its components. However, use of the surface 105 may be discretionary based on cost and needs.

Turning now to FIG. 12, a diagram of a power supply 110 for a remote station with alternative power sources is shown. The power supply 110 may include several subsystems including power conversion subsystems 115 and power generation subsystems 120.

The power conversion subsystem 115 may include a converter 125. In one embodiment, the converter converts a voltage input (typically 6, 12, 24 or 48 voltes) into various outputs 130, including 6, 24 and/or 48 volts. The voltage supply may also pass into an output 130. AC power such as 120V and 240V may also be available depending on the customers needs.

The power generation subsystem 120 may generate the power to the remote station. Solar panel power feeds 135 may be connected to a load controller 140. The load controller 140 may insure that adequate power is directed to the power conversion subsystem 115, while diverting excess power to other useful tasks, such as power storage 145.

Power storage 145 may comprise a series of batteries 150, that are charged during the day by excess power from the solar panel power feeds 135. At night, the load controller 140 may then cause the power storage 145 to supply power.

In one embodiment, the power generation subsystem 120 is redundant, such that there are two power generation subsystems 120 available. This may provide the advantage of allowing for a failure to occur, while still providing the necessary power. A controller may be signaled to use an onboard communications system to send a request for maintenance, in the event of a failure. Thus, the system may stay operative, even with a failure.

In another embodiment, the full power load is required. However, in the event of a failure, the system may gracefully degrade performance without ceasing operations entirely.

One advantage of the electrical system presented is that it may all reside upon the skid as a unit with the other accessories and technology. If needed, multiple systems can be connected together to provide power, communications and other needs adjacent the well.

It will be appreciated that the remote station 10 can be used for a variety of uses. For example, the remote station 10 could be used with a remote cabin which lacks access to electricity or telephone lines. The remote station could be brought in each time the cabin is in use, or could be left adjacent the cabin so that alternate power sources, such as electrical lines, propane or other power sources, may not be needed.

There is thus disclosed an improved minimally invasive remote power generation, control and communication system. It will be appreciated that numerous changes may be made to the present invention without departing from the scope of the claims.

What is claimed is:

1. An remote station comprising:
a skid configured to hold substantial portions of attached subsystems away from ground at a remote site; and
a power subsystem attached to the skid, the power subsystem comprising at least one power generation system and at least one power storage system.

2. The remote power station of claim 1, wherein the power generation system comprises at least one solar panel connected to the skid.

3. The remote power station of claim 1, wherein the power generation system comprises at least one LPG generator connected to the skid.

4. The remote power station of claim 1, wherein the power generation system comprises at least one propane tank connected to the skid.

5. The remote power station of claim 1, further comprising a communications subsystem.

6. The remote power station of claim 5, wherein the communications subsystem further comprises:
a tower attached to the base; and
an antenna attached to the tower.

7. The remote power station of claim 5, wherein the communications subsystem is configured to receive its power from the power subsystem.

8. The remote power station of claim 1, further comprising a loading connector configured to translate force applied to the connector into movement of the base.

9. A remote power station comprising:
a skid;
a power subsystem connected to the skid;
a loading connector attached to the skid;
a loading flange configured to hold a loading line to the loading connector; and
one or more containers attached to the skid.

10. The remote power station of claim 9, wherein the power subsystem further comprises a battery backup.

11. The remote power station of claim 10, wherein the power subsystem further comprises a solar power subsystem.

12. The remote power station of claim 11, wherein the power subsystem further comprises a load controller.

13. The remote power station of claim 11, wherein the power subsystem is redundant.

14. The remote power station of claim 9, wherein the one or more containers are weatherproof.

15. The remote power station of claim 9, wherein the skid further comprises rails.

16. The remote power station of claim 9, wherein the skid further comprises a filler configured to lower a center of gravity of the remote station.

17. The remote power station of claim 16, wherein the filler is cement.

18. The remote power station of claim 9, further comprising a wind turbine for generating power.

19. The remote power station of claim 9, comprising a structure configured to contain at least a portion of the power system.

20. A method of providing a remote power station, comprising:
providing a base;
attaching one or more subsystems to the base, at least one of the subsystems comprising means for generating power;
loading the base onto a vehicle;
transporting the base to a site remote from where the base was loaded onto a vehicle; and
unloading the base at the remote site.

21. The method according to claim 20, wherein the attaching step further comprises attaching a communications subsystem to the base.

22. The method according to claim 21, further comprising the steps of:
monitoring the remote station for subsystem failures; and
configuring the communications system to send a message in the event of a subsystem failure.

23. The method according to claim 20, wherein the method comprises attaching a loading line to a loading connector on the remote station prior to unloading the remote power station.

24. A method of providing a remote power station, comprising:
providing a skid;
attaching a power subsystem to the skid;
attaching one or more storage containers to the skid;
loading the skid onto a vehicle;
transporting the skid to a site remote from where the skid was loaded onto a vehicle;
attaching a loading line to a loading connector on the remote station;
using the loading line to slowly lower the skid down a ramp; and
unloading the skid at the remote site.

25. The method of providing a remote station of claim 24, further comprising selecting a skid having at least one solar panel attached to the skid and generating power from the at least one solar panel.

26. The method of providing a remote station of claim 25, wherein the method comprising selecting a skid having batteries attached thereto and storing and receiving power from one or more batteries.

27. The method of providing a remote station of claim 26, further comprising configuring a load controller to send excess power received from the at least one solar panel to charge the batteries.

28. The method of providing a remote station of claim 24, further comprising weatherproofing the one or more storage containers.

29. The method of providing a remote station of claim 28, further comprising placing portions or subsystems that require more frequent maintenance in a more accessible storage box.

30. The method of providing a remote station of claim 29, wherein the more accessible storage box is a building.

31. A method of providing an environmentally sensitive remote. power and communications station, comprising:
providing a skid;
attaching one or more subsystems and one or more communications devices to the skid;
loading the skid onto a vehicle;
transporting the skid to a site remote from where the base was loaded onto a vehicle;
unloading the skid at the remote site; and
preparing the skid to hold substantial portions of the attached subsystems at the remote site.

32. The method of providing an environmentally sensitive remote power and communications station of claim 31, further comprising adding a filler to the skid to reduce a center of gravity associated with the skid and attached subsystems.
